(19) United States
(12) Patent Application Publication
(10) Pub. No.: US 2009/0296073 A1
(43) Pub. Date: Dec. 3, 2009

(54) Method to create three-dimensional images of semiconductor structures using a focused ion beam device and a scanning electron microscope

(75) Inventor: Eric Wagganer, Fremont, CA (US)

Correspondence Address: SCHWEGMAN, LUNDBERG & WOESSNER, P.A., P.O. BOX 2938, MINNEAPOLIS, MN, 55402, US

(73) Assignee: LAM RESEARCH CORPORATION, Fremont, CA (US)

(21) Appl. No.: 12/128,420

(22) Filed: May 28, 2008

(51) Int. Cl. G01N 21/00

(52) U.S. Cl. 356/72

(57) ABSTRACT

A disclosed method produces an image of one or more fabricated features by iteratively producing a cross-section of the features. The method includes milling a surface proximate to the one or more fabricated features where the surface being milled is substantially parallel to a layer in which the feature is located. At each milling step, top-down imaging of the one or more fabricated features produces a plurality of cross-sectional images. Each of the plurality of cross-sectional images is reconstructed into a representation of the fabricated feature.

### TECHNICAL FIELD

The present invention relates generally to the field of metrology equipment used in the semiconductor, data storage, flat panel display, as well as allied or other industries. More particularly, the present invention relates to a method of three-dimensional imaging using a focused ion beam device and scanning electron microscope.

### BACKGROUND

Semiconductor device geometries (i.e., integrated circuit design rules) have decreased dramatically in size since integrated circuit (IC) devices were first introduced several decades ago. ICs have generally followed “Moore's Law,” which means that the number of devices fabricated on a single integrated circuit chip doubles every two years. Today's IC fabrication facilities are routinely producing 65 nm (0.065 μm) feature size devices, and future fabs will soon be producing devices having even smaller feature sizes.

The ever-decreasing feature sizes are driving both equipment suppliers and device manufacturers to inspect, and accurately and precisely measure, IC devices at various points during fabrication. Back-end-of-line electronic testing provides a go/no-go gauge as to the functionality of the IC, but analytical tools such as optical profilometers, atomic force microscopes, and critical-dimension scanning electron microscopes (CD-SEMs) are employed to image the topography of various portions of the IC. Cross-sectional (i.e., destructive) analysis provides for a root-cause analysis of failed ICs. Effective failure identification can often be performed only by cross-sectioning various devices within the IC and imaging the cross-sections with an electron microscope. Moreover, cross-sectional analyses provide important feed-back and feed-forward information on a process line.

Two methods are commonly used for cross-sectioning: cleaving wafers upon which the integrated circuits are located and ion milling the devices. Ion milling allows for better control in selecting small areas to inspect on the device. Ion milling removes material from the surface of an integrated circuit device by ablating atoms, thus removing them in layers from the device. After numerous passes, a trench is produced proximate to the structure allowing a “side-view” of the device using an SEM.

Ion milling is typically performed using a focused ion beam (FIB) device. FIB devices are frequently used in conjunction with an SEM. The SEM uses a focused beam of electrons to image a sample placed in a high-vacuum chamber. In contrast, a FIB uses a focused beam of ions.

Unlike an SEM, the FIB device is inherently destructive to the sample due to its energetic ions. Atoms are sputtered (i.e., physically removing atoms and molecules) from the sample upon impact from high-energy ions. The sputtering effect thus makes the FIB useful as a micro-machining tool. In addition to causing surface damage, the FIB device implants ions into the top few nanometers of the surface. The implantation frequently causes erroneous measurements, as will be discussed below.

Gallium is typically chosen as an ionic source for the FIB device since a gallium liquid metal ion source (LMIS) is relatively easy to fabricate. In a gallium LMIS, gallium metal is placed in contact with a tungsten needle. The combination is then heated. Gallium wets the tungsten and a large electric field (greater than 108 volts per centimeter) is generated. The large electric field causes ionization and field emission of gallium atoms.

The gallium ions are typically accelerated to an energy of 5-50 keV (kilo-electron volts), and focused by electrostatic lenses onto the sample. Contemporary FIB devices may deliver tens of nanoamps of current to the sample to aid in the milling process. Alternatively, the current may be reduced resulting in finer levels of milling with a concomitant reduction in spot size. The spot size can thus be controlled producing a beam only a few nanometers in diameter. Even thinner layers may be removed using, for example, a low voltage argon-ion beam.

With reference to FIG. 1A, a cross-section of a portion of an integrated circuit includes a base layer 101 and a dielectric layer 103. The dielectric layer 103 has a via 105A to connect an upper layer (not shown) subsequently formed over the dielectric layer 103 to the base layer 101.

In FIG. 1B, a series of ion beam milled layers has opened a deep trench 107A in front of an exposed via 105B. The deep trench 107A mills the bulk of the material away leaving only a small amount of the dielectric layer 103 in front of the via 105A. Each layer milled by the ion beam has a depth “d.” The deep trench 107A is thus formed by a series of progressively wider ions beam cuts into the dielectric layer 103. The depth “d” of each cut is typically on the order of tens to hundreds of nanometers. The actual depth is controlled by the energy of the ion beam and the amount of time the device is milled.

Once the deep trench 107A has been cut sufficiently deep by the focused ion beam device, a second round of passes using the FIB device removes layers of a remaining portion 107B of the dielectric layer 103 located immediately adjacent to the via 105A. After each cut in the remaining portion 107B of the dielectric layer 103 is made, a scanning electron microscope beam 109 is used to view the exposed via 105B at an angle, α, which is typically 15°-20°. FIG. 1C is a graphical depiction of an idealized cross-sectional view of the exposed via 105B as imaged by the scanning electron microscope beam 109 (FIG. 1B).

Focused ion beam (FIB) systems having a coaxial scanning electron microscope (SEM) are known in the art. The FIB can also be incorporated in a system with both electron and ion beam columns, allowing the same feature (e.g., such as the exposed via 105B) to be investigated using either of the beams.

Additionally, dual beam systems, including a FIB and a scanning electron microscope (SEM), have been introduced which can image the sample with the SEM and mill the sample using the FIB. Some dual beam instruments utilize coincident FIB and SEM beams, where the beams are incident upon the surface with a large angle between them.

As noted above, SEM imaging usually does not significantly damage a work piece surface, unlike imaging with an ion beam. In contrast to ions, electrons are ineffective at sputtering material. The amount of momentum that is transferred during a collision between an impinging particle and a substrate particle depends upon the momentum of the impinging particle and the relative masses of the two particles. Maximum momentum is transferred when the two particles have the same mass. When a mismatch exists between the mass of the impinging particle and that of the substrate particle, less of the momentum of the impinging particle is transferred to the substrate particle. A gallium ion used in FIB milling has a mass of over 128,000 times greater than that of an electron. As a result, the particles in a gallium ion beam possess sufficient momentum to sputter surface molecules. The momentum of an electron in a typical SEM electron beam is not sufficient to remove molecules from a surface by momentum transfer.

However, the inherent damage caused by FIB milling frequently causes damage to the feature to be imaged as well. Therefore, features are typically filled with another material to act as a protective layer. The other material is typically chosen to have similar mechanical etching characteristics and a similar scattered electron rate as the feature material. For example, a dielectric layer such as silicon dioxide may be filled with a tungsten (W) or platinum (Pt) coating. Although the contrasting material protects the feature from excessive damage, the protective layer causes a phenomenon known as “curtaining” to affect the accuracy of a subsequent SEM measurement. Curtaining is caused by the energetic gallium ions being implanted in non-etched layers.

With reference to FIG. 2, a via 203 fabricated in a dielectric 201 is overcoated with a tungsten protective layer 205. The tungsten protective layer 205 insures structural integrity of the via 203 during FIB milling. Additionally, the tungsten protective layer 205 assures a necessary contrast difference for edge-finding and critical dimension (CD) measurements of the via 203. However, both an overall actual height, h₁, and actual width, w₁, of the via 203 are difficult to discern. As is well-known in the art, curtaining results from the milling process associated with using tungsten (or various other materials) as implanted ions partially obscure material boundaries. Actual edges of the via 203 become ill-defined. CD measurements of height and width of the via 203 may be erroneously interpreted as being h₂ and w₂, respectively.

Thus, prior art FIB-SEM imaging techniques present numerous challenges arising from both (1) curtaining effects and (2) the inordinate amount of time required to conduct angular cutting of a deep trench in the sample prior to final milling and imaging steps. Therefore, what is needed is an efficient and accurate method to determine three-dimensional CD measurements of various features on a semiconductor integrated circuit. The method should avoid curtaining effects and provide true three-dimensional imaging of any feature.

### SUMMARY

In an exemplary embodiment, a method of producing cross-sectional imaging of a fabricated feature is disclosed. The method comprises milling a surface proximate to the fabricated feature where the milled surface is substantially parallel to a layer in which the feature is located. The fabricated feature is imaged from a position substantially normal to the milled surface thus producing a first of a plurality of cross-sectional images.

In another exemplary embodiment, a method of producing an image of one or more fabricated features is disclosed. The method comprises iteratively producing a cross-section of the one of more features including ion milling a surface proximate to the one or more fabricated features, where the milled surface is substantially parallel to a layer in which the feature is located, and performing top-down imaging of the one or more fabricated features thus producing a plurality of cross-sectional images.

In another exemplary embodiment, a method of producing an image of one or more fabricated features is disclosed. The method comprises iteratively producing a cross-section of the one of more features including ion milling a surface proximate to the one or more fabricated features, the milled surface being substantially parallel to a layer in which the feature is located, and performing top-down imaging of the one or more fabricated features using a scanning electron microscope thereby producing a plurality of cross-sectional images. Each of the plurality of cross-sectional images is reconstructed into a representation of the fabricated feature.

### BRIEF DESCRIPTION OF THE DRAWINGS

The appended drawings merely illustrate exemplary embodiments of the present invention and must not be considered as limiting its scope.

FIG. 1A is a cross-sectional view of a via of the prior art.

FIG. 1B is a cross-sectional view of a trench formed next to and exposing the via of FIG. 1A by a series of cuts produced by a focused ion beam.

FIG. 1C is an idealized representation of the exposed via of FIG. 1B as imaged by an angled scanning electron microscope beam.

FIG. 2 is a cross-sectional representation of a via indicating a prior art curtaining effect on critical dimensional measurements.

FIG. 3A is a cross-sectional representation of a via exhibiting twisting.

FIG. 3B is the via of FIG. 3A filled with a protective material showing various FIB etch steps.

FIG. 4 shows a plurality of cross-sectional areas obtained images taken after each of the FIB etch steps of FIG. 3B.

FIG. 5 shows the plurality of cross-sectional areas of FIG. 4 combined to reconstruct the via of FIG. 3A into two-dimensional and three-dimensional representations.

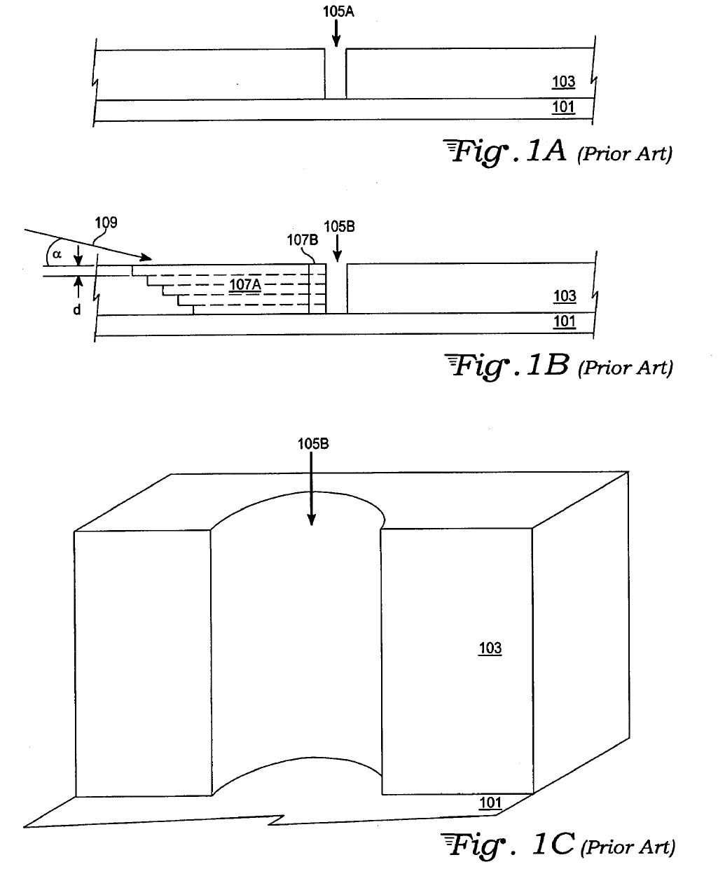

### DETAILED DESCRIPTION

Various embodiments discussed below disclose a method to provide two-dimensional and three-dimensional imaging of various feature types. The embodiments use a layering system whereby top-down views, rather than side views, are imaged onto an SEM. Consequently, no trench needs to be etched alongside a feature as required by the prior art. Rather, a plurality of steps is milled parallel to the layering material surrounding the feature under inspection. After each step is milled, a top-down image is formed of the feature.

The embodiments disclosed herein significantly reduce the time required to both prepare a sample for SEM imaging and actual data collection and imaging. For example, the embodiments disclosed eliminate the prior art requirement of cutting a FIB trench adjacent to a sample feature that is sufficiently large to allow an SEM beam to image the feature. Consequently, the time to prepare and image a feature goes down from minutes required by the prior art, to seconds under the present invention. Further, if the FIB cut goes below the feature, the milling process can simply be stopped and a subsequent feature can be identified. Milling and imaging can begin again immediately.

A skilled artisan will immediately recognize numerous advantages upon reading the various embodiments disclosed. For example, multiple features (e.g., lines, holes, ovals, etc.) can be simultaneously imaged for statistical comparison. Irregular shapes (e.g., ovals) can be analyzed. As the cuts and top-down SEM images are collected, a fabrication time-evolution can be produced showing phenomena like high-aspect ratio twisting. Further, FIB-SEM imaging time can be reduced from, for example, more than 5 minutes per site to less than 1 minute per site (depending on the milling rate and depth of the feature). Also, etch phenomena such as etch stops, striations, and line-edge or via-edge roughness may all be analyzed readily.

Further, as described in more detail below, features of interest for certain materials may require protection from the ion beam to prevent excessive surface and ion implantation (I²) damage. Such protection can be achieved by filling in any proximate open spaces with a metal (e.g., tungsten (W), titanium (Ti), copper (Cu), etc.) or dielectric (e.g., spin-on glass (SOG) to prevent excessive damage from the milling process. By implementing embodiments of the present invention as defined herein, time can again be saved over prior art methods by entirely coating an entire wafer or substrate prior to FIB-SEM analysis rather than coating within the FIB-SEM at each feature site as is required under the prior art.

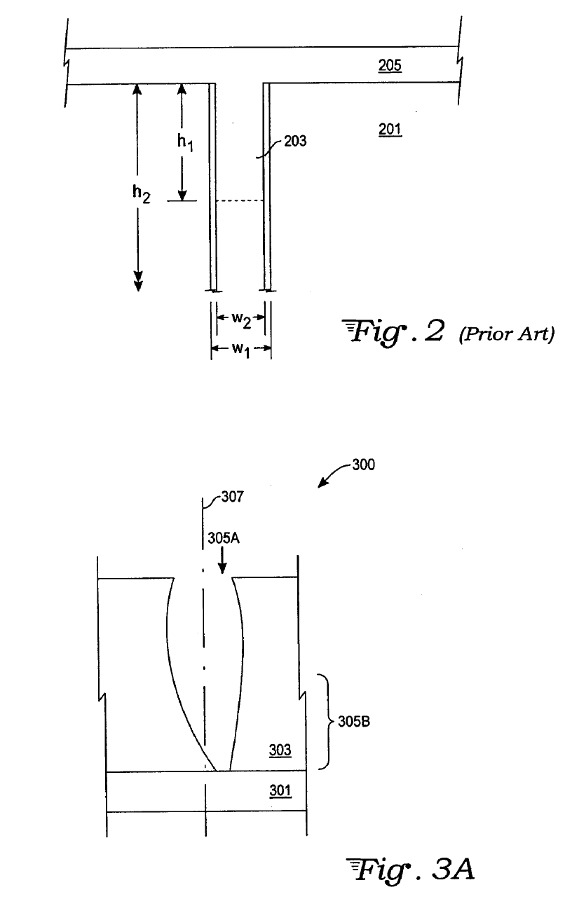

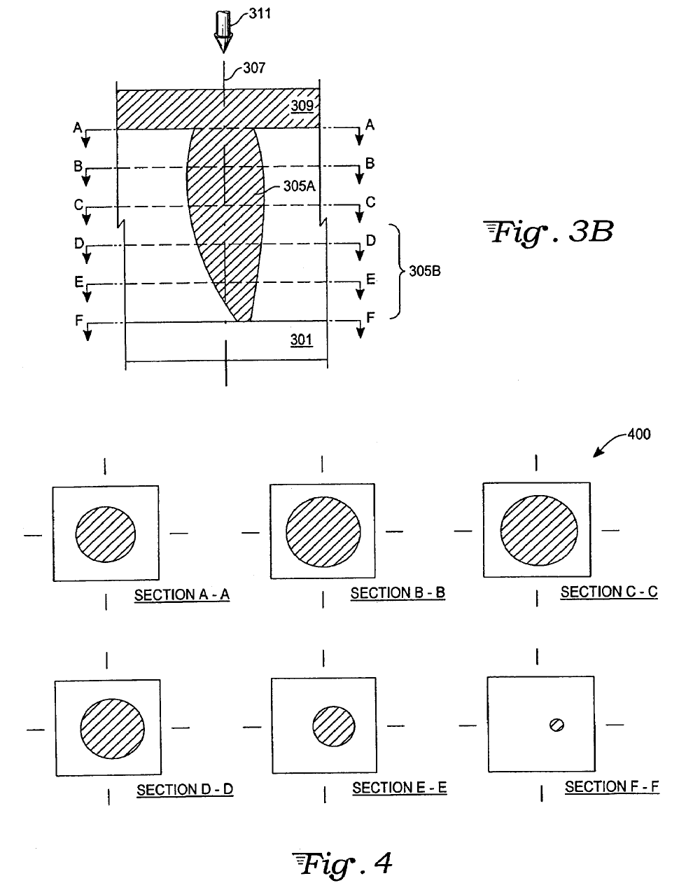

Referring now to FIG. 3A, a cross-sectional view of a portion of a semiconductor device 300 includes a base layer 301 and a dielectric layer 303. The dielectric layer 303 has a via 305A formed therein. The via 305A has a lower portion 305B which exhibits “twisting” frequently encountered and known in the art when high-aspect ratio vias (i.e., vias having a height to width ratio of more than approximately 30:1) are formed. A centerline reference fiducial 307 indicates a deviation due to the twisting in the lower portion 305B of the via 305A.

In FIG. 3B, the via 305A has been filled with a protective material 309. The protective material 309 may comprise, for example, tungsten (W), platinum (Pt), spin-on glass (SOG), boro-phospho-silicate glass (BPSG), or a variety of other materials known in the art. The protective material 309 may be selected based upon the material into which the feature under inspection is fabricated. For example, if the feature is comprised of soft material such as copper (Cu), a protective material with similar etching or milling characteristics may be selected to keeping milling rates consistent.

As is known in the art, electrostatic lenses in the FIB device column may be used to raster scan the FIB beam in an x-y orientation (i.e., where an x-y plane is parallel to a face of an underlying substrate upon which the semiconductor device is fabricated). The ion beam current may be varied depending upon how large of milled step is desired and a composition of the materials to be etched. FIG. 3B shows a variety of cross-sectional markings, A-F, indicating steps milled by a FIB device. However, since the FIB device is capable of milling steps from tens to several hundreds of nanometers at a time, a skilled artisan will recognize that either a small or very large number of steps may be utilized in the disclosure that follows.

After each step is milled, a scanning electron microscope beam 311 is directed to scanning the milled and exposed section. Since an angled SEM beam is not required, a top-down CD-SEM may be readily employed for this step as well, thereby increasing a level of accuracy with which each section is measured.

Since only a top-down SEM need be employed, any tunneling or implantation effects from the ion milling are mitigated. Thus, the deleterious curtaining effects of the prior art, described above, will have little if any effect on edge-boundary determinations further assuring accurate sizing of the cross-sectional feature. Moreover, since all imaging is relatively planar (i.e., a three-dimensional imaging scan is not required), a low accelerating voltage may be applied to the SEM thus minimizing or eliminating charging effects if non-conductive features are imaged. Another advantageous benefit is that sidewall roughness of any feature will be imaged at each step by the top-down SEM. Thus, evolutionary information of formation of the feature during fabrication may be gleaned.

With reference to FIG. 4 and continued reference to FIG. 3B, various cross-sectional SEM images 400 correspond to each of the plurality of steps exposed by ion milling in FIG. 3B. As noted by the cross-sectional SEM images 400, especially with reference to sections D-D through F-F, the twisting in the lower portion 305B of the via 305A is readily discernible. Since the cross-sections of the via 305A imaged are each imaged by a top-down SEM beam 311, the twisting will always appear regardless of the orientation of the SEM beam 311 with respect to the via 305A. Thus, no alignment of the feature is needed to image the twisting effect.

In contrast, the prior art could completely miss any twisting effects depending upon the angle from which the images were captured. For example, if the via 305A of FIG. 3B were imaged from the left side using traditional milling and side-imaging techniques, the twisting effect would be undiscovered. Further, the via 305A would be inaccurately characterized by the prior art for length (even assuming no curtaining effects) due to the foreshortening which would occur (i.e., the intersection of the left-hand sidewall profile of the via 305B combined with the centerline reference fiducial 307). The true bottom of the via 305A would not be found without additional milling.

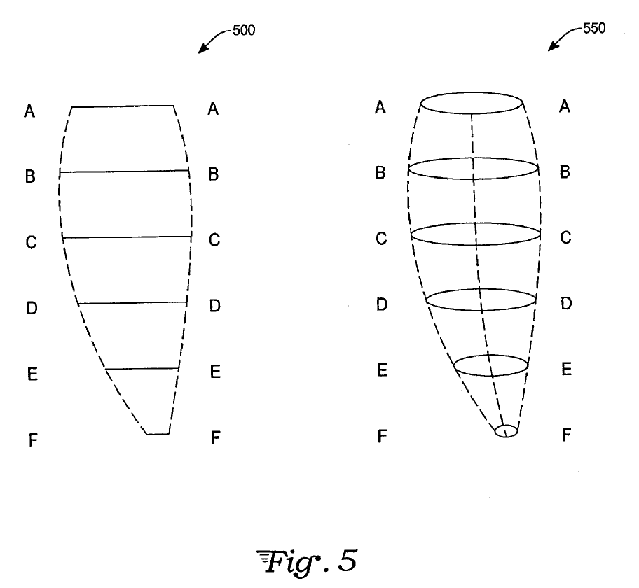

FIG. 5 indicates a possible two-dimensional reconstruction 500 of the via 305A (FIG. 3B). Each of the cross-sectional SEM images 400 (FIG. 4) are arranged, in order, to provide an overall cross-section of the via 305A. The two-dimensional reconstruction 500 may be rotated to show the via 305A from various angles since all data are available from the cross-sectional SEM images 400. Moreover, a three-dimensional reconstruction 550 may be constructed in similar fashion. Each of the reconstructions 500, 550 may be solid-modeled as well depending upon metrological requirements for analysis of the imaged feature. Software for combining, rotating, and solid-modeling such images to form the reconstructions 500, 550 is known in the art.

The present invention is described above with reference to specific embodiments thereof. It will, however, be evident to a skilled artisan that various modifications and changes can be made thereto without departing from the broader spirit and scope of the present invention as set forth in the appended claims.

For example, particular embodiments describe a number of material types and layers employed. A skilled artisan will recognize that these materials and layers are flexible and are shown herein for exemplary purposes only in order to illustrate the novel nature of the three-dimensional imaging method. Additionally, a skilled artisan will further recognize that the techniques and methods described herein may be applied to any sort of structure. The application to a semiconductor via feature was purely used as an exemplar to aid one of skill in the art in describing various embodiments of the present invention.

Further, a skilled artisan will recognize, upon a review of the information disclosed herein, that other types of milling devices other than ion milling may be used. For example, material may be removed in steps by a laser oblation device.

Also, a number of analytical tools other than an SEM may be used to image the feature. For example, if the feature is not filled with a protective material, a number of devices such as an optical profilometer, or an atomic force microscope or other mechanical profiling device, can be used to image the feature. Even if the feature is filled, a scattering technique such as Raman spectroscopy or angle-resolved light scattering may be employed to image the feature at successive levels or cuts.

Moreover, the term semiconductor should be construed throughout the description to include data storage, flat panel display, as well as allied or other industries. These and various other embodiments are all within a scope of the present invention. The specification and drawings are, accordingly, to be regarded in an illustrative rather than a restrictive sense.

What is claimed is:

1. A method of producing cross-sectional imaging of a fabricated feature, the method comprising:
milling a surface proximate to the fabricated feature, the surface being milled substantially parallel to a layer in which the feature is located; and
imaging the fabricated feature from a position substantially normal to the milled surface thus producing a first of a plurality of cross-sectional images.

2. The method of claim 1 further comprising:
iterating the milling and imaging steps along an overall height of the feature; and
reconstructing each of the plurality of cross-sectional images into a representation of the fabricated feature.

3. The method of claim 2 further comprising reconstructing the fabricated feature as a two-dimensional representation.

4. The method of claim 2 further comprising reconstructing the fabricated feature as a three-dimensional representation.

5. The method of claim 1 further comprising selecting the milling step to be performed by a focused ion beam device.

6. The method of claim 1 further comprising selecting the milling step to be performed by a laser oblation device.

7. The method of claim 1 further comprising selecting the imaging step to be performed by a scanning electron microscope.

8. The method of claim 7 further comprising selecting the scanning electron microscope to be a critical-dimension top-down scanning electron microscope.

9. The method of claim 1 further comprising selecting the imaging step to be performed by a light scattering device.

10. The method of claim 1 further comprising selecting the imaging step to be performed by a profiling device.

11. The method of claim 1 further comprising protecting the fabricated feature by filling any open portions of the feature with a material dissimilar to a material comprising the layer in which the feature is fabricated.

12. A method of producing an image of one or more fabricated features, the method comprising:
iteratively producing a cross-section of the one of more features, including
ion milling a surface proximate to the one or more fabricated features, the surface being milled substantially parallel to a layer in which the feature is located; and
performing top-down imaging of the one or more fabricated features thus producing a plurality of cross-sectional images.

13. The method of claim 12 further comprising reconstructing each of the plurality of cross-sectional images into a representation of the fabricated feature.

14. The method of claim 12 further comprising selecting the imaging step to be performed by a scanning electron microscope.

15. The method of claim 14 further comprising selecting the scanning electron microscope to be a critical-dimension scanning electron microscope.

16. The method of claim 12 further comprising selecting the imaging step to be performed by a light scattering device.

17. The method of claim 12 further comprising selecting the imaging step to be performed by a profiling device.

18. The method of claim 12 further comprising protecting the fabricated feature by filling any open portions of the feature with a material dissimilar to a material comprising the layer in which the feature is fabricated.

19. A method of producing an image of one or more fabricated features, the method comprising:
iteratively producing a cross-section of the one of more features, including
ion milling a surface proximate to the one or more fabricated features, the surface being milled substantially parallel to a layer in which the feature is located; and
performing top-down imaging of the one or more fabricated features using a scanning electron microscope thus producing a plurality of cross-sectional images; and
reconstructing each of the plurality of cross-sectional images into a representation of the fabricated feature.

20. The method of claim 19 further comprising reconstructing the fabricated feature as a three-dimensional representation.

21. The method of claim 20 wherein the three-dimensional representation is rotatable.

22. The method of claim 19 further comprising protecting the fabricated feature by filling any open portions of the feature with a material dissimilar to a material comprising the layer in which the feature is fabricated.
